(19) United States
(12) Patent Application Publication
(10) Pub. No.: US 2026/0310032 A1
(43) Pub. Date: Oct. 8, 2026

(54) SOLUTION-PHASE NEAR INFRARED ABSORBING AND ELECTRO-OPTIC VISIBLE ABSORBING DEVICES

(71) Applicant: Gentex Corporation, Zeeland, MI (US)

(72) Inventor: Kelvin L. Baumann, Holland, MI (US)

(73) Assignee: Gentex Corporation, Zeeland, MI (US)

(21) Appl. No.: 19/640,098

(22) Filed: Apr. 6, 2026

Related U.S. Application Data
(60) Provisional application No. 63/784,670, filed on Apr. 7, 2025.

(51) Int. Cl. G02F 1/137; G02F 1/1516

(52) U.S. Cl. CPC G02F 1/137; G02F 1/1516; G02F 2203/11

(57) ABSTRACT

An electro-optic assembly includes a front substrate defining a first surface and a second surface, the second surface includes a first electrically conductive layer, a back substrate defining a third surface and a fourth surface, the third surface includes a second electrically conductive layer, and an electro-optic medium disposed between the second surface and the third surface, the electro-optic medium has a decrease in transmission in near infrared light range with a first applied electrical potential to said electro-optic assembly, the electro-optic medium has a decrease in transmission in the visible light range with a second applied electrical potential applied to the electro-optic assembly.

### CROSS-REFERENCE TO RELATED APPLICATION

This application claims priority to and the benefit under 35 U.S.C. § 119 (e) of U.S. Provisional Patent Application No. 63/784,670, filed on Apr. 7, 2025, entitled SOLUTION-PHASE NEAR INFRARED ABSORBING AND ELECTRO-OPTIC VISIBLE ABSORBING DEVICES, the entire disclosure of which is hereby incorporated herein by reference.

### FIELD OF THE DISCLOSURE

The present disclosure generally relates to an electro-optic device absorbing near infrared and visible light wavelengths, and more particularly to an electro-optic device absorbing near infrared and visible light wavelengths using solution-phase electrochromic chemistry.

### SUMMARY OF THE DISCLOSURE

According to one aspect of the present disclosure, an electro-optic assembly includes a front substrate defining a first surface and a second surface, the second surface includes a first electrically conductive layer, a back substrate defining a third surface and a fourth surface, the third surface includes a second electrically conductive layer, and an electro-optic medium disposed between the second surface and the third surface, the electro-optic medium has a decrease in transmission in near infrared light range with a first applied electrical potential to said electro-optic assembly, the electro-optic medium has a decrease in transmission in the visible light range with a second applied electrical potential applied to the electro-optic assembly.

According to another aspect of the present disclosure, a device for filtering near infrared and visible light includes a front substrate defining a first surface and a second surface, a back substrate defining a third surface and a fourth surface, a cavity is defined between the front substrate and the back substrate, an electro-optic medium disposed in the cavity, the electro-optic medium is operable between a clear state when no electrical potential is applied to said device, an intermediate state when a first electrical potential is applied to said device, and a darkened state when a second electrical potential is applied to said device.

According to another aspects of the present disclosure, an electro-optic medium for absorbing near infrared and visible light, including a cathodic component, where the cathodic component is at least one of 1,1′-di(octyl) 4,4′-dipyridinium bis(tetrafluoroborate) or 1,1′-bis(ethylhexyl)-4,4′-dipridinium-bis(tetrafluoroborate), and an anodic component, where the anodic component includes, N-isobutyl-3,7-bis(dimethyl amino) phenothiazine, at least one of 5,10-dihydro-5,10-dimethyl phenazine or 5,10-dihydro-5,10-dineopentyl phenazine, and at least one of 5,10-dihydro-5,10-dineopentyl-2,7-bis(2-ethylhexyl) phenazine or 5,10-dihydro-5,10-dineopentyl-2,7-di(isobutyl) phenazine, and where the electro-optic medium has a first transmission of visible and near infrared light when no electrical potential is applied of greater than 55%, and has a second transmission of near infrared light when a first electrical potential is applied of less than 20%.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional schematic view of an electro-optic element according to aspects of the present disclosure;

FIG. 2A is a flow diagram of a method of transitioning between different states of a single stage electro-optic device according to aspects of the present disclosure;

FIG. 2B is a flow diagram of a method of transitioning between different states of a dual stage electro-optic device according to aspects of the present disclosure;

FIG. 3 is a graph showing the UV cycling stability of a single stage electro-optic element according to aspects of the present disclosure;

FIG. 4 is a graph showing cycling at 70° C. of a single stage electro-optic element according to aspects of the present disclosure;

FIG. 5 is a graph showing the storage durability at 85° C. of a single stage electro-optic element according to aspects of the present disclosure;

FIG. 6 is a graph showing the UV static durability of a single stage electro-optic element according to aspects of the present disclosure;

FIG. 7 is a graph showing the transmission electromagnetic spectrum over 21 weeks in a single stage electro-optic element after storage at 85° C. according to aspects of the present disclosure;

FIG. 8 is a graph showing the transmission electromagnetic spectrum over 21 weeks in a single stage electro-optic element during long duty UV cycling according to aspects of the present disclosure;

FIG. 9 is a graph showing the transmission electromagnetic spectrum over 21 weeks in a single stage electro-optic element during the cycling at 70° C. according to aspects of the present disclosure;

FIG. 10 is a graph showing the oxidation states of different solution-phased chemicals according to aspects of the present disclosure;

FIG. 11 is a graph showing current plots at 0.5 V and 1.0 V of a dual stage electro-optic element according to aspects of the present disclosure;

FIG. 12 is a transmission graph of a UV/Vis spectrum plot at different electrical potentials of a two dual electro-optic element according to aspects of the present disclosure;

FIG. 13 is graph showing a Current-Voltage plot of a dual stage electro-optic element according to aspects of the present disclosure;

FIG. 14 is a graph showing the visible light degradation plot of a 70° C. cycling of a dual stage electro-optic element according to aspects of the present disclosure;

FIG. 15 is a graph showing the visible light degradation plot of a 3 hours on/1 hour off cycling behind a UVEP blocker of a dual stage electro-optic element according to aspects of the present disclosure;

FIG. 16 is a graph of the transmission of the electromagnetic spectrum over 21 weeks of cycling at 70° C. of a dual stage electro-optic element according to aspects of the present disclosure; and

FIG. 17 is a graph of the transmission of the electromagnetic spectrum over 24 weeks of UV cycling behind a UVEP blocker of a dual stage electro-optic element according to aspects of the present disclosure.

### DETAILED DESCRIPTION

The present illustrated embodiments reside primarily in combinations of method steps and apparatus components related to solution-phase near infrared absorbing and electro-optic visible absorbing devices. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

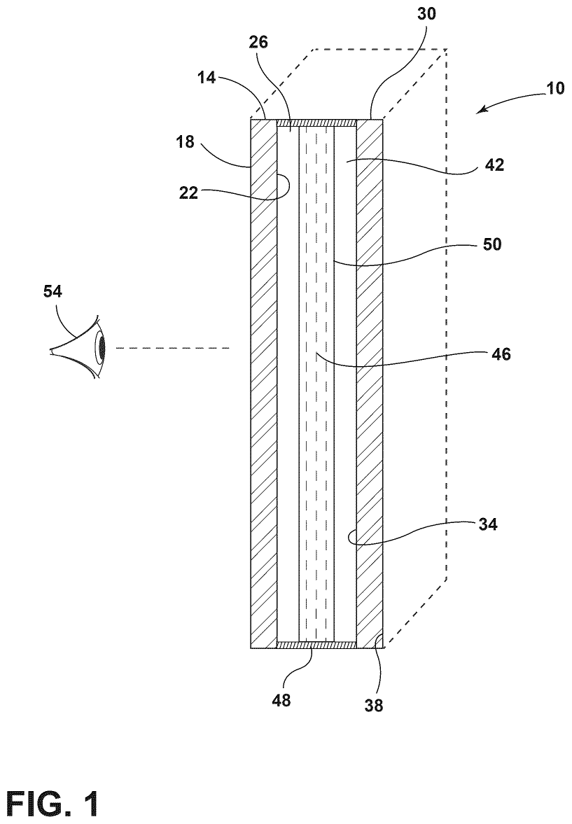

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIG. 1, an electro-optic element 10 or assembly may include a front substrate 14 defining a first surface 18 and a second surface 22. The second surface 22 may include a first electrically conductive layer 26. The electro-optical elements 10 may also include a rear or back substrate 30 defining a third surface 34 and a fourth surface 38. The third surface 34 may include a second electrically conductive layer 42. A reflective layer 42 may also be disposed on the third surface 34. An electro-optic medium 46 may be disposed between the second surface 22 and the third surface 34. The electro-optic medium 46 may be configured to have a decrease in transmission in near infrared light range with a first applied electrical potential to the electro-optic element 10. The electro-optic medium 46 may further be configured to have a decrease in transmission in the visible light range with a second applied electrical potential applied to the electro-optic element 10.

According to some aspects of the present disclosure, reference numeral 10 generally designates an electro-optic element including an electro-optic medium 46. The electro-optic element 10 includes a front substrate 14, with a first surface 18 and second surface 22. The electro-optic element 10 further includes a rear substrate 30, with a third surface 34 and a fourth surface 38. An optical coating may be disposed on the front substrate 14 or the rear substrate 30. In some examples, the optical coating may be on the third surface 34.

The present disclosure relates to an electro-optic device with solution-phase near infrared absorbing and visible light absorbing capacity. In some aspects, the electro-optic device may be a single stage device whereby both near infrared wavelengths and visible wavelengths of light may be absorbed when an electrical potential is applied to the electro-optic device. In other aspects, the electro-optic device may be a dual stage device, whereby near infrared wavelengths of light are absorbed when a first electrical potential is applied to the electro-optic device and visible and near infrared light is absorbed when a second electrical potential is applied to the electro-optic device. In various examples, in dual stage devices, the first electrical potential may be a larger magnitude than the second electrical potential; likewise, the first electrical potential may be a smaller magnitude than the second electrical potential. Further, in both the single stage device and the dual stage device, neither visible wavelengths of light nor near infrared wavelengths of light may be absorbed when no electrical potential is applied to the electro-optic device or very little visible wavelengths or near infrared wavelengths of light are absorbed. In various examples, visible light may exist as wavelengths between about 380-780 nm; further near-infrared (IR) light may exist as wavelengths between about 700-2,500 nm.

The solution-phase near infrared absorbing visible light absorbing electro-optic capability may be used in electro-optic elements 10 and electrochromic devices incorporating such electro-optic elements. By way of further introduction, electro-optic devices generally include an electro-optic medium 46 that transitions between an inactivated state in which the electrochromic medium 46 is relatively transparent to light having a wavelength within a predetermined wavelength range and an activated state in which the electro-optic medium 46 has a decreased transmission to light within a predetermined wavelength range when an electrical potential is applied to the electrochromic device. The predetermined wavelength range may be, in some examples, visible light and/or near infrared light. The electro-optic medium 46 is disposed between an anodic component and a cathodic component which may also be referred to as electroactive components, at least one of which may also be electrochromic. The anodic and cathodic components may, alternatively, be referred to as chromophores, electrochromic moieties, molecules or dyes, or electrochromic polymers. The electrochromic and/or electroactive component can provide the electrochromic device with a perceived color when the electrochromic device is in the activated state and/or as the device transitions between the inactivated and activated states.

Electrochromic components, as described herein, include materials whose color or opacity are affected by an electrical current, such that when an electrical field is applied to the material, the color or opacity changes from a first state to a second state (e.g., the inactivated and activated states). Thus, an electro-optic device can exhibit a change in transparency as a result of electrochemical oxidation and reduction reactions that occur between electroactive components (e.g., the anodic components and the cathodic components), in which at least one of the electroactive components is also electro-optic. In other words, when a sufficient electrical potential difference is applied across electrodes of an electro-optic device, the electro-optic medium can shift from a substantially clear state (e.g., a high transmission state, such as the inactivated state) to a substantially dark or darkened state (e.g., a low transmission state, such as the activated state), as well as intermediate states thereto, in the event that one or more of the anodic and the cathodic components are oxidized and reduced, respectively. Specifically, the anodic components are oxidized by donating electrons to the anode and the cathodic components are reduced by accepting electrons from the cathode. The substantially clear and/or substantially dark or darkened states may refer to one or more of visible light and near infrared light.

Referring to FIG. 1, an exemplary electro-optic element 10 including an electro-optic medium 46 including both of the anodic component and cathodic component is illustrated. The electro-optic medium 46 is disposed between a first electrically conductive layer 26 and a second electrically conductive layer 42. The first and second electrically conductive layers 26, 42 may act as electrodes. In one example, one or both of the chromophores may be in solution and able to diffuse between the adjacent electrode and an opposing electrode.

Referring still to FIG. 1, the electro-optic element 10 can include a front substrate 14 having a first surface 18 and a second surface 22. The first electrically conductive layer 26 is disposed on the second surface 22. A rear substrate 30 is provided opposite the front substrate 22 and includes a third surface 34 and a fourth surface 38. The second electrically conductive layer 42 is disposed on the third surface 34. The front substrate 14 and the rear substrate 30, along with a sealing member 48 define a chamber 50 for containing the electro-optic medium 46 therein. The front substrate 14 and the rear substrate 30 may be substantially parallel. The first surface 18 and the third surface 34 may be oriented toward a front direction of the electro-optical element 10. The second surface 22 and the fourth surface 38 may be oriented towards a rear direction of the electro-optical element 10. A direction of view 54 of electro-optical element 10 may be from the front direction to the rear direction.

The electro-optic element 10 allows the electro-optic device to be operable between a first state of the electro-optic element 10, which allows electromagnetic radiation having a wavelength within a predetermined wavelength range to pass through, and a second state, in which a portion, or no electromagnetic radiation having a wavelength within a predetermined wavelength range, is transmitted through the electro-optic element 10 (e.g., the electro-optic element 10 becomes generally darkened or generally opaque or partially opaque to electromagnetic radiation having a wavelength within the predetermined wavelength range). The second state of the electro-optic element 10 can be defined relative to the transmissivity of the first state. According to an aspect of the present disclosure, the transmissivity of electromagnetic radiation of a predetermined wavelength or wavelength range through the electro-optic element 10 in the first state may be greater than about 10%, greater than about 12%, greater than about 25%, greater than about 50%, greater than about 55%, or greater than about 85%. Typically, the percentage of reflectance, transmittance, and absorbance of the electro-optic element 10 sum to 100%. In some aspects, the transmissivity of electromagnetic radiation of the predetermined wavelength or wavelength range through the electro-optic element 10 in the second state may be less than about 10%, less than about 1%, less than about 0.1%, less than about 0.01%, or less than about 0.001%. According to further aspects of the present disclosure, the electro-optic element 10 may transition between the first and second state through an applied electrical stimulus or the removal of an active electrical stimulus. Additionally or alternatively, the electro-optical element 10 may be self-erasing, that is, the default state, the state without an electrical stimulus, is the second state. According to still further aspects of the present disclosure, the electro-optic element 10 may have further intermediate states between the first and the second states. The intermediate states may exist when an electrical potential is applied to the electro-optic element that is of an intensity between that of the first and second states. In some examples, in one of the intermediate states it may be possible to reduce the transmission of light of a first predetermined wavelength, while the transmission of light of a second predetermined wavelength may be reduced in the second state. In some further examples, the first predetermined wavelength may include light in the infrared or near infrared spectrum while the second predetermined wavelength may include light in the visible spectrum. In contrast, in other examples, the first predetermined wavelength may include light in the visible spectrum while the second predetermined wavelength may include light in the infrared or near infrared spectrum. It can be contemplated that the electro-optic element 10 may have further intermediate states that may be able to reduce the transmission of different wavelengths other than visible or near infrared light.

Referring still to FIG. 1, the front and/or rear substrates 14, 30 may be made of glass, plastic, or other optically transparent or translucent material(s), non-limiting examples of which include borosilicate glass, soda lime glass, or polymeric materials, such as natural and synthetic polymeric resins, plastics, and/or composites. Non-limiting examples of such include polyesters (e.g., PET), polyimides (PI), polycarbonates, polysulfones, polyethylene naphthalate (PEN), ethylene vinyl acetate (EVA), acrylate polymers, as well as cyclic olefin copolymers (COC) and cyclic olefin polymers (COP) (such as those commercially available from TOPAS® Advanced Polymers). In some aspects, both the front and rear substrates 14, 30 are made of an optically transparent or translucent material, while, in other aspects, only a single substrate, such as the front substrate 14, is made of an optically transparent or translucent material. The front and rear substrates 14, 30 can be made from the same or different materials and may have the same or different dimensions.

According to aspects of the present disclosure, the electro-optic element 10 may have a transflective coating which may be disposed on the second, third, or fourth surface 22, 34, 38. The transflective coating may comprise one or more layers of metal, dielectric and/or transparent conducting oxides. The visible reflectance and transmittance of the transflective coating may vary depending on design considerations of the electro-optic element 10. In further aspects of the present disclosure, the transflective coating may be a transflective dielectric coating or dielectric mirror stack. The dielectric mirror stack may act as the first electrically conductive layer 26 on the second surface 22 or the second electrically conductive layer 42 on the third surface 34. Accordingly, the electrically conductive material(s) forming the first and second electrically conductive layers 26, 42 may be the same or different. Non-limiting examples of electrically conductive material that may be used to form the first and/or second electrically conductive layers 26, 42 can include transparent conductive oxides (TCOs) such as fluorine doped tin oxide (FTO), for example TEC™ glass, indium tin oxide (ITO), doped zinc oxide, indium zinc oxide (IZO), aluminum doped zinc oxide (AZO), metal oxide/metal/metal oxide (including, where the metal oxide can be substituted with metal carbide, metal nitride, metal sulfide, etc.), nanowires, wire mesh, and carbon based conductors.

Referring to the exemplary electro-optic element 10 illustrated in FIG. 1, the sealing member 48 may traverse, or extend along, and cooperate with an approximate perimeter of, the front and rear substrates 14, 30 to define the chamber 50 as substantially hermetic. The sealing member 48 may be disposed around a perimeter of the electro-optic medium 46 (e.g., extending from the second surface 22 to the third surface 34). The sealing member 48 may be in the form of any suitable seal type and material. For example, the sealing member 48 may include thermoset epoxy.

According to aspects of the present disclosure, the electro-optic device using the electro-optic element 10 may act as a light filter. The light filter may have a pre-determined wavelength that is filtered from passing through the electro-optic device or absorbed while other wavelengths may pass through the electro-optic device. In some non-limiting examples, the pre-determined wavelength may be infrared light, near infrared light, or visible light. According to further aspects of the present disclosure, the electro-optic device may act as a light filter only when an applied electrical potential is applied to the electro-optic device. In various aspects, the light filter may be contemplated with two configurations: a single stage and a dual stage. The single stage electro-optic device acting as a light filter may have two modes, the first mode where no or little light is absorbed, and a second mode where at least two pre-determined wavelengths of light are absorbed. In some examples, the first mode may be referred to as a clear state. To proceed from the first mode to the second mode a specific full electrical potential may be applied to the device. Non-limiting examples of uses of the single stage electro-optic device include a device to reduce glare and/or brightness and a device that blocks heat from near infrared light. The dual stage electro-optic device may have at least one intermediate mode or state between the first mode, where no or little light is absorbed, and the second mode where at least two pre-determined wavelengths are absorbed. In the dual stage electro-optic device, to proceed from the first mode to the at least one of the intermediate modes a specific partial electrical potential may be applied. The partial electrical potential may be smaller than the full electrical potential. In some examples, the dual stage electro-optic device may allow transmission of all light when no electrical potential is applied; the dual stage electro-optic device may absorb near infrared light when a partial electrical potential is applied and allow transmission of visible light; the dual stage electro-optic device may absorb both near infrared light and visible light when a full electrical potential is applied. Non-limiting examples of the dual stage electro-optic device include dimmable windows that may block heat generated from near infrared light in auto, residential, or light pipes.

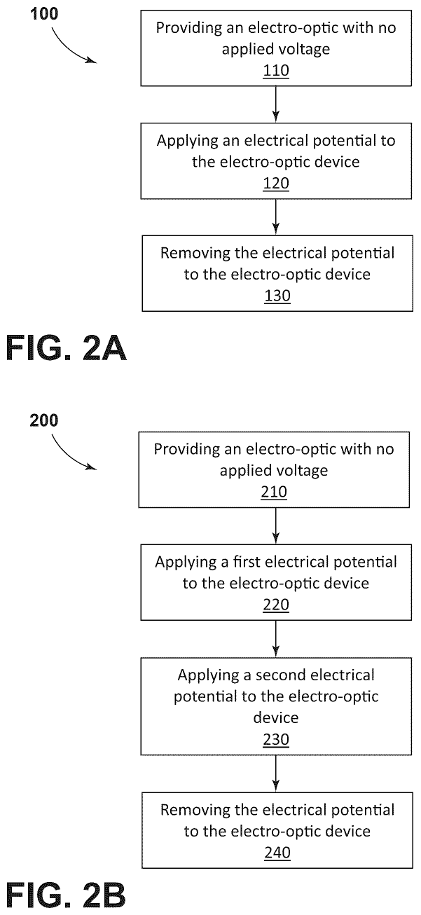

Referring now to FIG. 2A, a method 100 may be used to transition between different states of a single stage electro-optic device 10. The method 100 includes providing an electro-optic device with no electric potential applied to the electro-optic device (step 110). During step 110, the electro-optic device may be considered in a first state. The first state may also be called a clear state, where the electro-optic device is transmissive to light in both the visible and near infrared wavelengths. Next the method 100 includes applying an electrical potential to the electro-optic device (step 120). During step 120, the electro-optic device may be considered in a second state which may be called a darkened state. The second state, includes the electro-optic device that may be transmissive to light to both visible and near infrared wavelengths by less than about 10%, less than about 1%, less than about 0.1%, less than about 0.01%, or less than about 0.001%. Next, a step 130 of removing the electrical potential to the electro-optic device may be performed. During step 130, the electro-optic device may be considered to return to the first state and therefore may be transmissive to light in both the visible and near infrared wavelengths.

Referring now to FIG. 2B, a method 200 may be used to transition between different states of a dual stage electro-optic device 10. The method 200 includes providing an electro-optic device with no electric potential applied to the electro-optic device (step 210). During step 210, the electro-optic device may be considered in a first state. The first state may also be called a clear state, where the electro-optic device is transmissive to light in both the visible and near infrared wavelengths. Next, the method 200 includes applying a first electrical potential to the electro-optic device (step 220). During step 220, the electro-optic device may be considered in a second state or intermediate state. In the second state, the electro-optic device may be transmissive to light of near infrared wavelengths by less than about 10%, less than about 1%, less than about 0.1%, less than about 0.01%, or less than about 0.001%, as well as be transmissive to light in the visible spectrum by greater than about 10%, greater than about 12%, greater than about 25%, greater than about 50%, greater than about 55%, or greater than about 85%. Next, the method 200 includes applying a second electrical potential to the electro-optic device (step 230). The second electrical potential may be greater than the first electrical potential. During step 230, the electro-optic device may be considered in a third state. In the third state, the electro-optic device may be transmissive to light of both visible and near infrared wavelengths by less than about 10%, less than about 1%, less than about 0.1%, less than about 0.01%, or less than about 0.001%. Next, a step 240 of removing the electrical potential to the electro-optic device may be performed. During step 240, the electro-optic device may be considered to return to the first state and therefore may be transmissive to light in both the visible and near infrared wavelengths. Additionally or alternatively, it may be possible to skip step 230 of applying a second electrical potential and proceed directly to step 240 of removing the electrical potential. Further, it may also be possible to proceed from step 230 of applying a second electrical potential to step 220. In proceeding from step 230 to step 220, the electrical potential applied to the electro-optic device may be decreased from the second electrical potential to the first electrical potential; as such, the electro-optic device may proceed from have a reduced transmission to both visible and near infrared light, as in the third state, to having a reduced transmission of only infrared light, as in the second state.

### EXAMPLES

### Example 1: Single Stage Near IR/Visible Light Absorbing Device

### Formulation of the Electro-Optic Medium

The electro-optic medium includes 72.7 mM 1,1′-di(2-ethylhexyl)-4,4′-dipridinium-bis(tetrafluoroborate); 36.3 mM 5,10-dihydro-5,10-dineopentyl phenazine; 6.3 mM 5,10-dihydro-5,10-dineopentyl-2,7-di(isobutyl) phenazine; 13.3 mM N-isobutyl-3,7-bis(dimethyl amino) phenothiazine; 0.5 mM octamethyl-bis(hexano pivalate) ferrocene; 16.9 mM octamethyl-bis(hexano pivalate) ferrocenium bis(tetrafluoroborate); 170 mM oxybenzone; 30 mM Tinuvin Pentyl Ester; 2.8% 1:10 2-hydroxyethyl methacrylate/methylacrylate copolymer; 0.19% Lupranate-MI, 10 ppm dibutyltin diacetate; and using propylene carbonate as a solvent.

Alternative components to the above formula include: 1,1′-di(octyl) 4,4′-dipyridinium bis(tetra fluoroborate) in place of 1,1′-bis(2-ethylhexyl)-4,4′-dipridinium-bis(tetra fluoro borate); 5,10-dihydro-5,10-dimethyl phenazine in place of 5,10-dihydro-5,10-dineopentyl phenazine; and 5,10-dihydro-5,10-dineopentyl-2,7-bis(2-ethylhexyl) phenazine in place of 5,10-dihydro-5,10-dineopentyl-2,7-di(isobutyl) phenazine.

The following components acted as cathodic compounds: 1,1′-bis(2-ethylhexyl)-4,4′-dipridinium-bis(tetrafluoroborate) and 1,1′-di(octyl) 4,4′-dipyridinium bis(tetra fluoroborate).

The following components acted as anodic compounds: 5,10-dihydro-5,10-dimethyl phenazine; 5,10-dihydro-5,10-dineopentyl phenazine; 5,10-dihydro-5,10-dineopentyl-2,7-bis(2-ethyl hexyl) phenazine; and 5,10-dihydro-5,10-dineopentyl-2,7-di(isobutyl) phenazine.

### Single Stage Device Performance

A single stage device was fabricated with a 200 μm cell spacing using the above formulation for the electro-optic medium. The device made a neutral color with no electrical potential applied. When an electrical potential was applied in the range of 0.6-0.9 V the device absorbed both near IR and visible light resulting in a gray coloration. In near IR ranges, the transmission at 940 nm started at 68.9% with 0 V applied and reduced to 0.40% when 1.0 V were applied for a resulting contrast ratio of 172.3. Likewise in visible ranges, the transmission started at 83.85% with 0 V applied and reduced to 0.2% when 1.0 V was applied for a resulting contrast ratio of 419. Therefore, 1.0 V may be suited to achieve the full strength of visible light and near IR light absorption.

The single stage device underwent various performance tests. Typically, UV testing was performed with Xenon arc lamp 1 sun weatherometer testing and all UV testing was performed behind a UVEP filter.

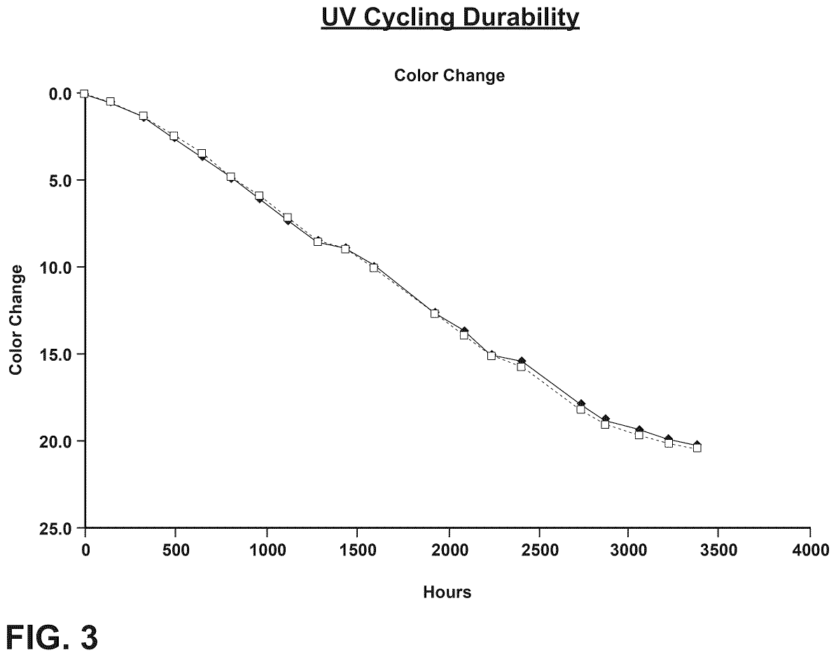

UV cycling durability, as shown in FIG. 3, to show the ability of the solution to withstand exposure to UV light over a period of time which results in a graph of color change with respect to time. The UV cycling includes simulation of repeated exposure to UV light alternating between 0 V and 1.0 V applied voltage.

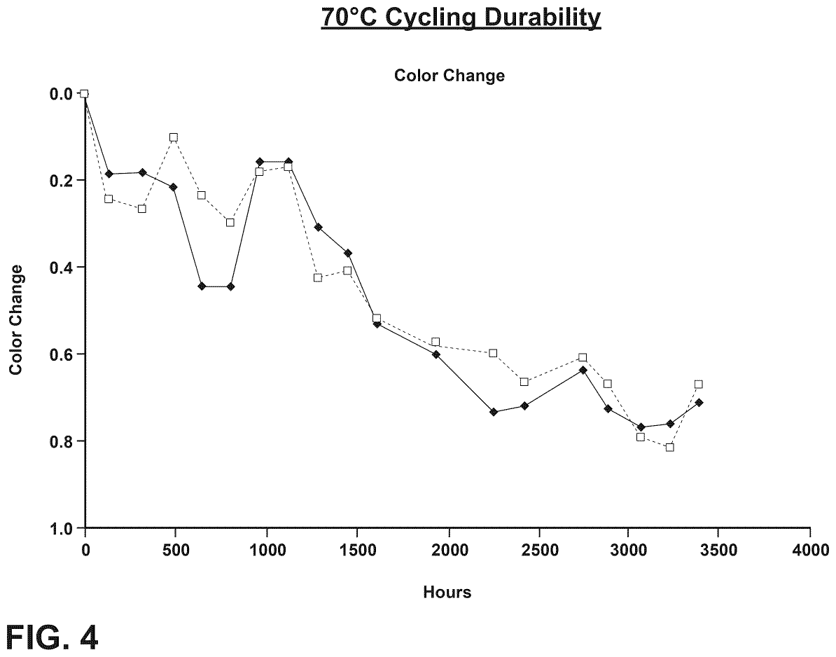

The device was further tested with cycling at 70° C. for durability, as shown in FIG. 4, to show the color change with respect to time. The temperature cycling subjected the solution to a high temperature with alternating applied voltages between 0 V and 1.0 V with a goal to assess how the device would withstand thermal stress over time.

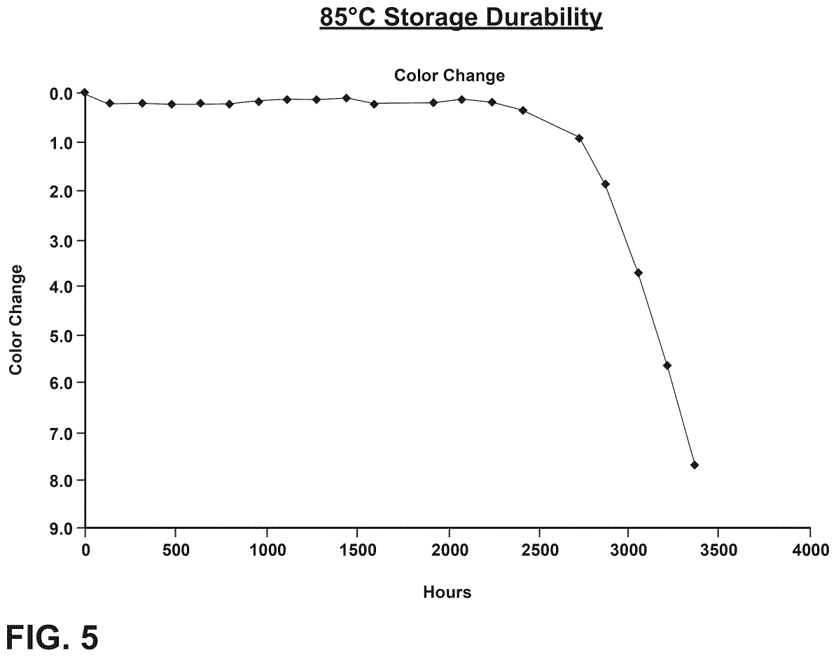

The storage durability at 85° C., as shown in FIG. 5, shows the color change with respect to time. The storage durability was evaluated to determine how well the device maintained its performance at static high temperatures.

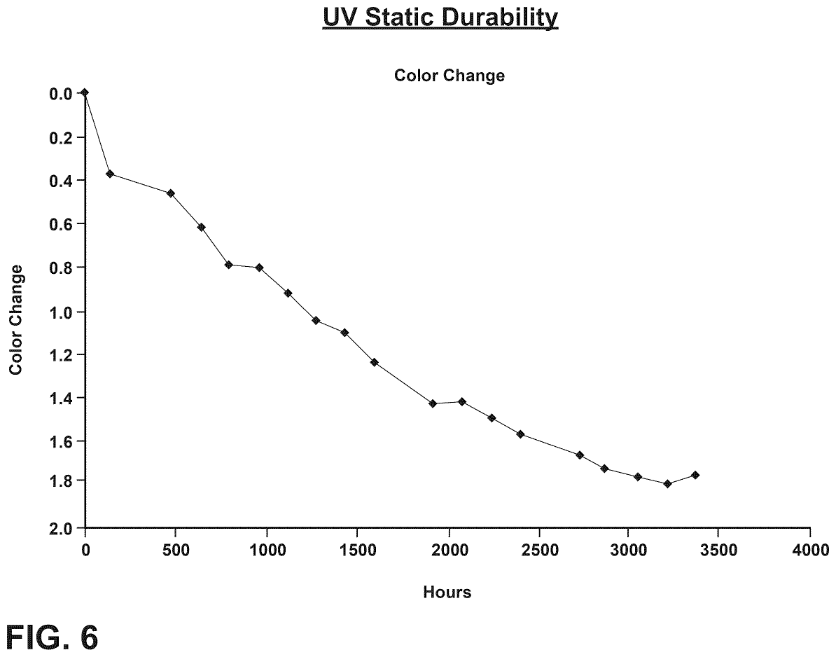

UV static durability, as shown in FIG. 6, shows the color change with respect to time. The UV static durability test was to evaluate how well the device resisted degradation when exposed to UV light under stationary conditions over time in a clear state.

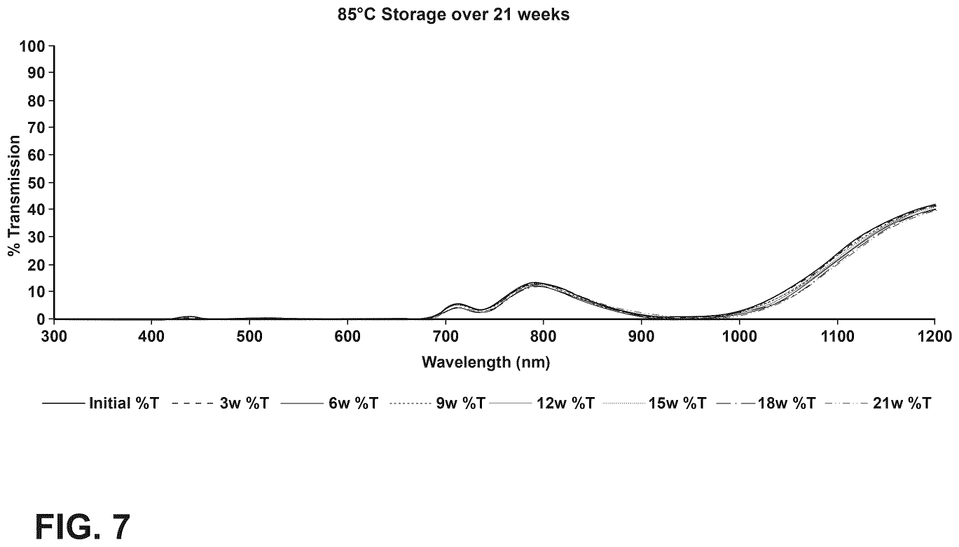

The single stage device further underwent various tests, reevaluating the percentage transmission at 940 nm from 0 to 21 weeks. Referring to FIG. 7, the device was held at 85° C. with no cycling and tested after 21 weeks and resulted in a transmission change at 940 nm from 0.29 to 0.42%.

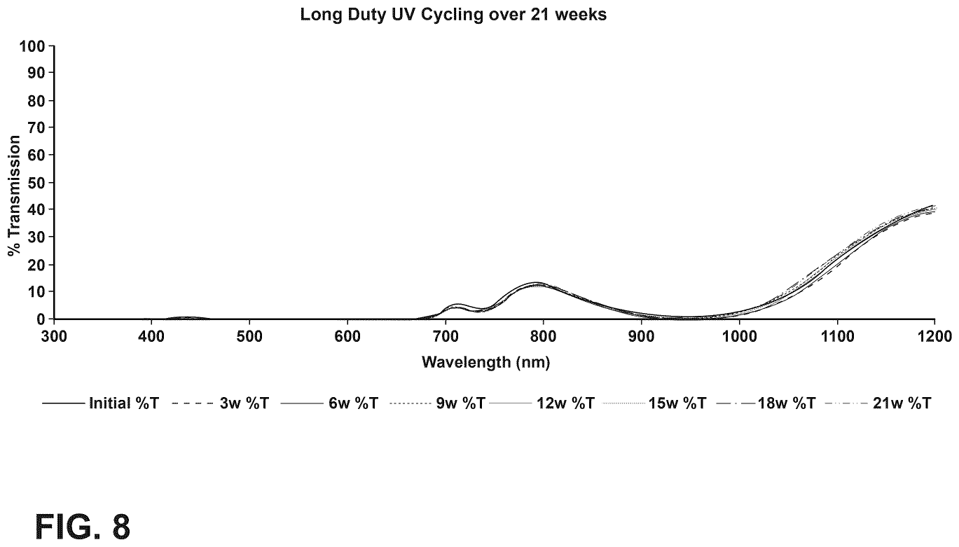

Referring to FIG. 8, the device was cycled under UV light in repeated cycles for a long duty UV cycling test. This tested the device after 21 weeks while exposed to UV light alternating 3 hours on (1.0 V) and 1 hour off (0 V), which resulted in a transmission change at 940 nm from 0.29 to 0.68%.

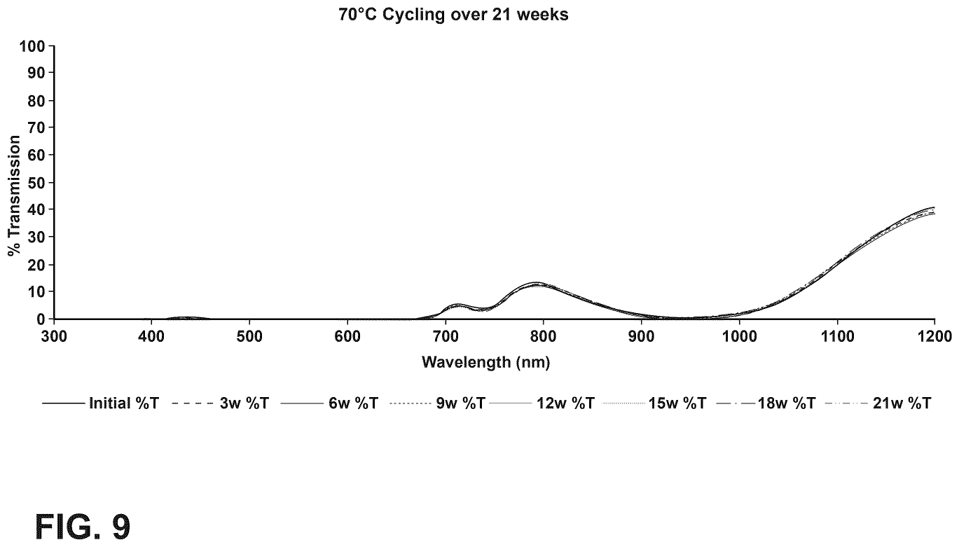

Referring to FIG. 9, the device was cycled under UV light in repeated cycles for a UV cycling test at 70° C. which resulted after 21 weeks in a transmission change at 940 nm from 0.29 to 0.68%.

### Example 2: Dual Stage Near IR/Visible Light Absorbing Device

### Formulation of the Electro-Optic Medium

The electro-optic medium includes 32 mM 1,1′-bis(2-ethylhexyl)-4,4′-dipridinium-bis(tetrafluoroborate); 13.3 mM N-isobutyl-3,7-bis(dimethyl amino) phenothiazine; 20.25 mM 5,10-dihydro-5,10-dineopentyl phenazine; 6.75 mM 5,10-dihydro-5,10-dineopentyl-2,7-di(isobutyl) phenazine; 0.5 mM octamethyl-bis(hexano pivalate) ferrocene; 16.9 mM octa methyl-bis(hexano pivalate) ferrocenium bis(tetrafluoroborate), 170 mM oxybenzone; 30 mM Tinuvin pentyl ester; 2.8% Copolymer of 1:10 2-hydroxy methacrylate and methyl acrylate; 0.19% Lupranate MI; 10 ppm dibutyl tin diacetate; and using propylene carbonate as a solvent.

Alternative components to the above formula include: 1,1′-di(octyl) 4,4′-dipyridinium bis(tetra fluoroborate) in place of 1,1′-bis(2-ethylhexyl)-4,4′-dipridinium-bis(tetrafluoro borate); 5,10-dihydro-5,10-dimethyl phenazine in place of 5,10-dihydro-5,10-dineopentyl phenazine; 5,10-dihydro-5,10-dineopentyl-2,7-di(isobutyl) phenazine in the place of 5,10-dihydro-5,10-dineopentyl-2,7-di(2-ethyl hexyl) phenazine

The following components act as cathodic compounds: 1,1′-di(octyl) 4,4′-dipyridinium bis(tetrafluoroborate) and 1,1′-bis(2-ethylhexyl)-4,4′-dipridinium-bis(tetrafluoroborate).

The following components act as anodic compounds: N-isobutyl-3,7-bis(dimethyl amino) phenothiazine; 5,10-dihydro-5,10-dimethyl phenazine; 5,10-dihydro-5,10-dineopentyl phenazine; 5,10-dihydro-5,10-dineopentyl-2,7-bis(2-ethylhexyl) phenazine; and 5,10-dihydro-5,10-dineopentyl-2,7-di(isobutyl) phenazine.

### Dual Stage Device Performance

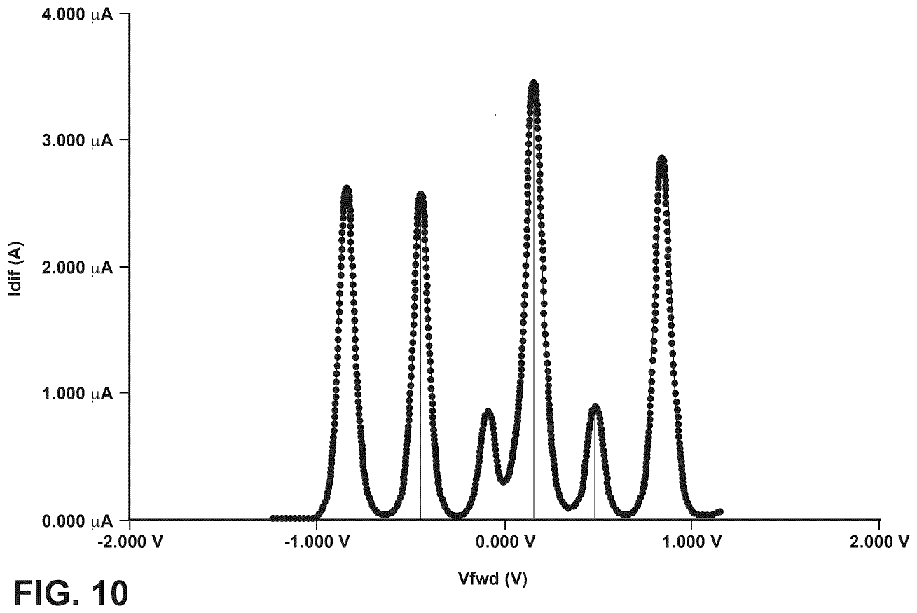

A dual stage device was fabricated with a cell spacing of 200 μm using the above formulation for the electro-optic medium. To analyze the electro-optical medium of this device, FIG. 10 shows the oxidation states of different solution-phased chemicals using differential pulse voltammetry (DPV). The two peaks on the left resulted from the reduction of the cathodic components, in this case 1,1′-di(octyl) 4,4′-dipyridinium bis(tetrafluoroborate). The smaller third peak results from the octamethyl-bis(hexano pivalate) ferrocenium bis(tetrafluoroborate). The fourth and largest resulted from the anodic components, from the near IR component, 5,10-dihydro-5,10-dimethyl phenazine and 5,10-dihydro-5,10-dineopentyl-2,7-di(isobutyl) phenazine. The fifth small peak resulted from the second near IR peak. The right most peak resulted from the second oxidation state of the anodic components 5,10-dihydro-5,10-dimethyl phenazine and 5,10-dihydro-5,10-dineopentyl-2,7-di(isobutyl) phenazine. The solution of the dual stage device was able to absorb near IR when an electrical potential was applied to the device from 0.4-0.6 V. An increase in the electrical potential from 0.6-0.9 V resulted in the solution absorbing in the visible range to result in a gray coloration. See Table 1 for a summary of the transmission results (% T) of the dual stage device. The near IR was measured at 940 nm.

TABLE 1

| Electrical Potential | % T of Near IR | % T of Visible |
|---|---|---|
| 0.0 V | 67% | 78% |
| 0.5 V | 18.7% | 59.7% |
| 1.0 V | 0.75% | 7% |

As illustrated in Table 1, From 0.0-0.5 V there was a decrease in visible light transmission by 23.5% while there was a decrease in near infrared transmission by 72.1%. When 0.5 V is applied to the device from 0.0 V, the near IR drop in transmission is approximately 3 times the drop of visible light transmission. The contrast ratio at 940 nm of near infrared light at 0.5 V was about 3.6 and at 1.0 V was about 68. The contrast ratio of visible light at 0.5 V was about 1.3 and at 1.0 V was about 10.

The dual stage device underwent various characterization and performance tests. Typically, for UV testing was performed with Xenon arc lamp 1 sun weatherometer testing and all UV testing was performed behind a UVEP filter.

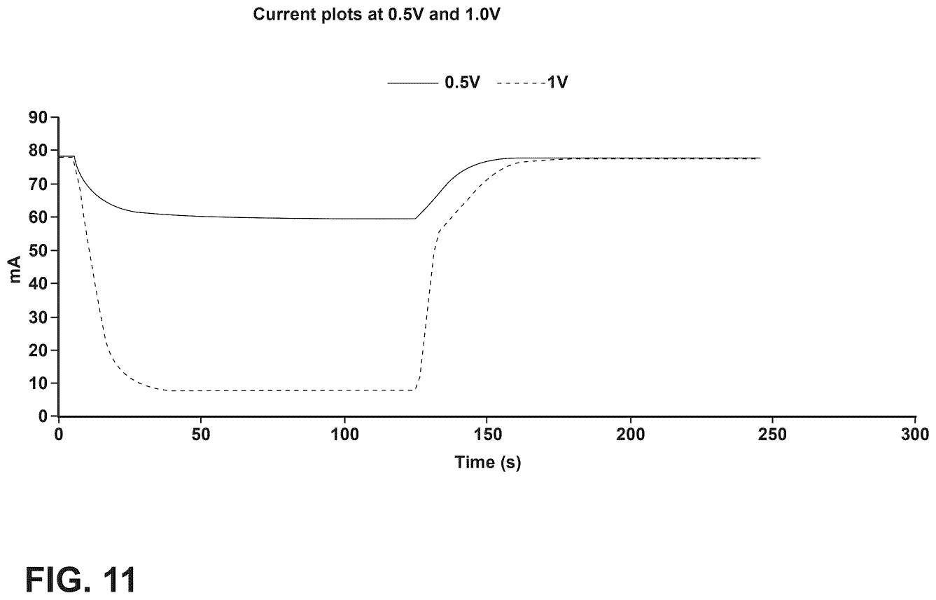

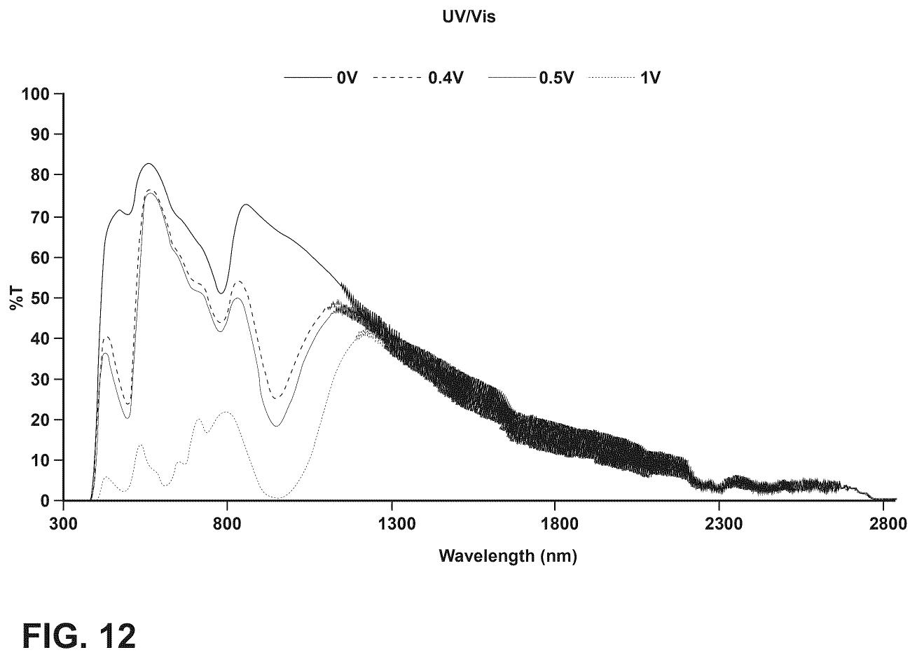

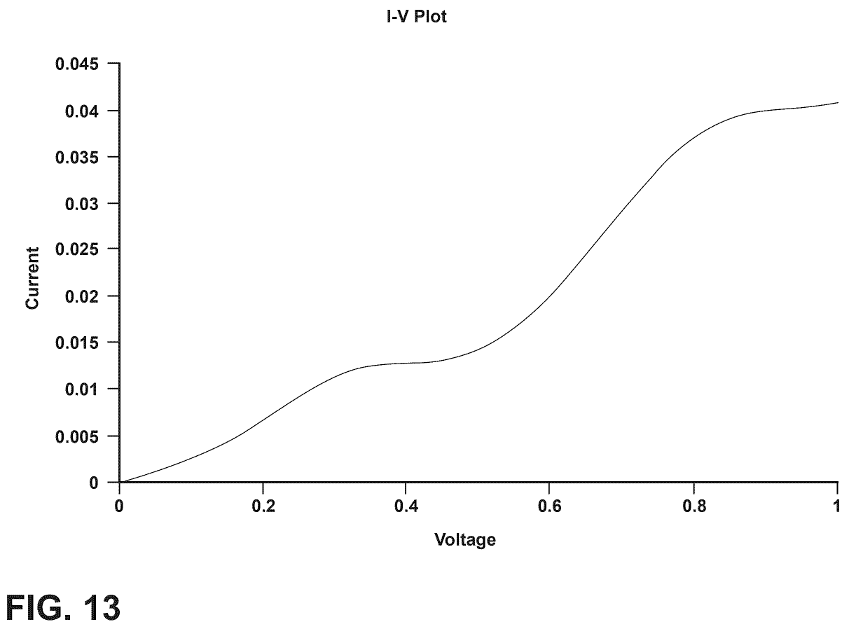

Referring to FIG. 11, this plot quantified the electric current with respect to time when two different electrical potentials were 0.5 V and 1.0 V. For further characterization, FIG. 12 shows a UV/Vis plot of the dual stage device across 0.0, 0.4, 0.5, and 1 V to illustrate the absorption of near IR and visible wavelengths. FIG. 13 shows an I-V plot to show the relationship between current flowing through the device as a voltage is applied.

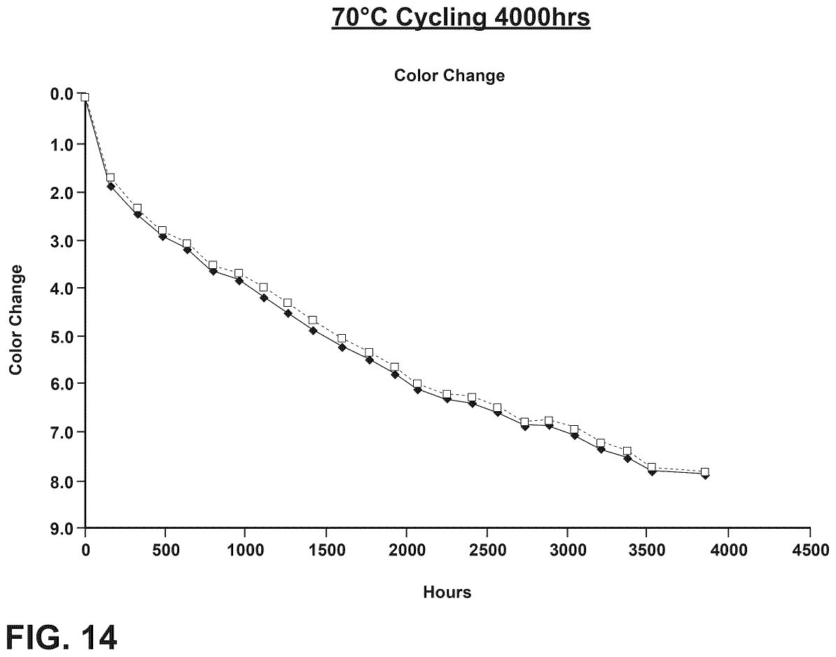

The device was further tested with cycling at 70° C. for durability, as shown in FIG. 14, to show the color change with respect to time. The temperature cycling subjected the solution to a high temperature with alternating clear to darkened state with a goal of assessing how the solution would withstand thermal stress over time.

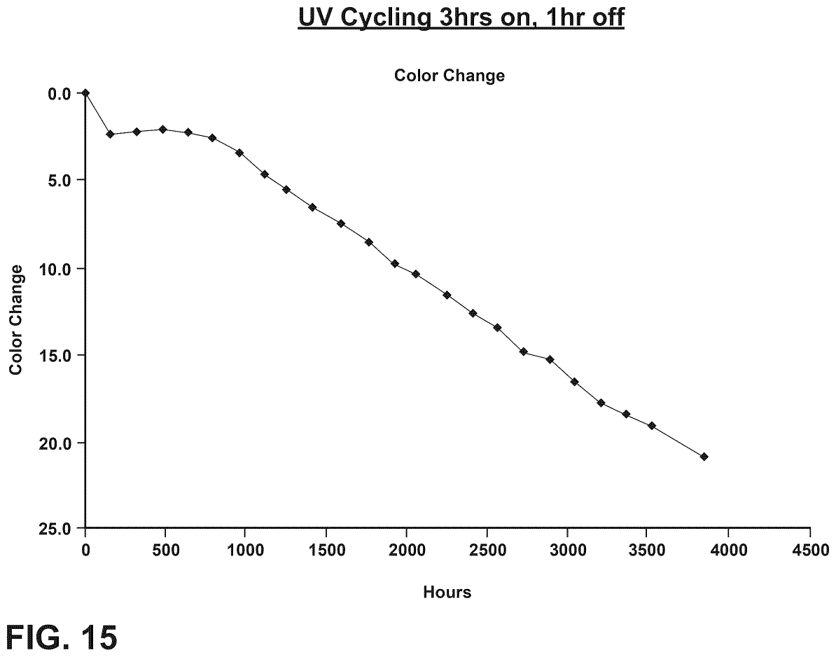

Referring to FIG. 15, the device was cycled under UV light while behind a UVEP blocker. This tested the device alternating 3 hours on (darkened) and 1 hour off (clear) and showed the color change with respect to time.

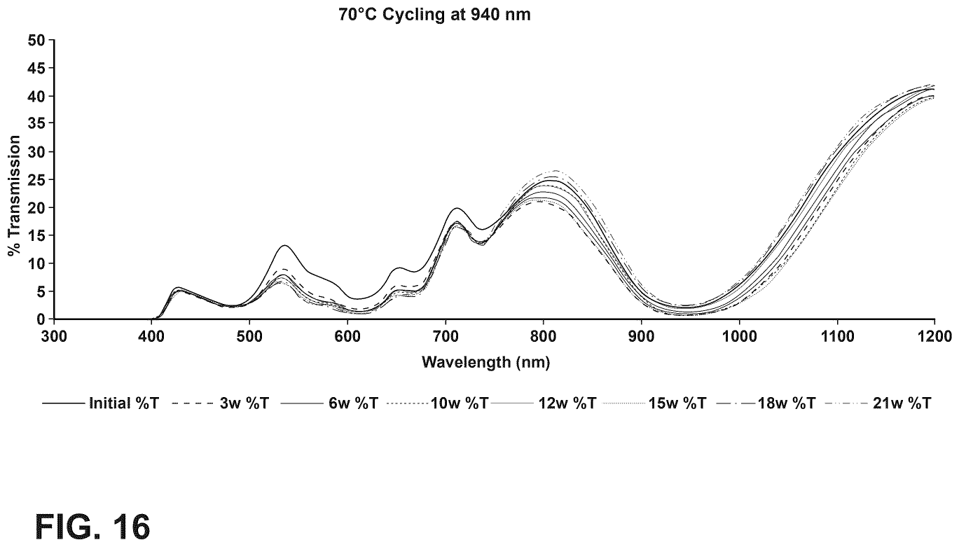

Referring to FIG. 16, the device was cycled at 70° C. alternating between 3 hours in a darkened state followed 1 hour in a clear state. This tested the device after 21 weeks which resulted in a transmission change at 940 nm from 0.64 to 2.48%.

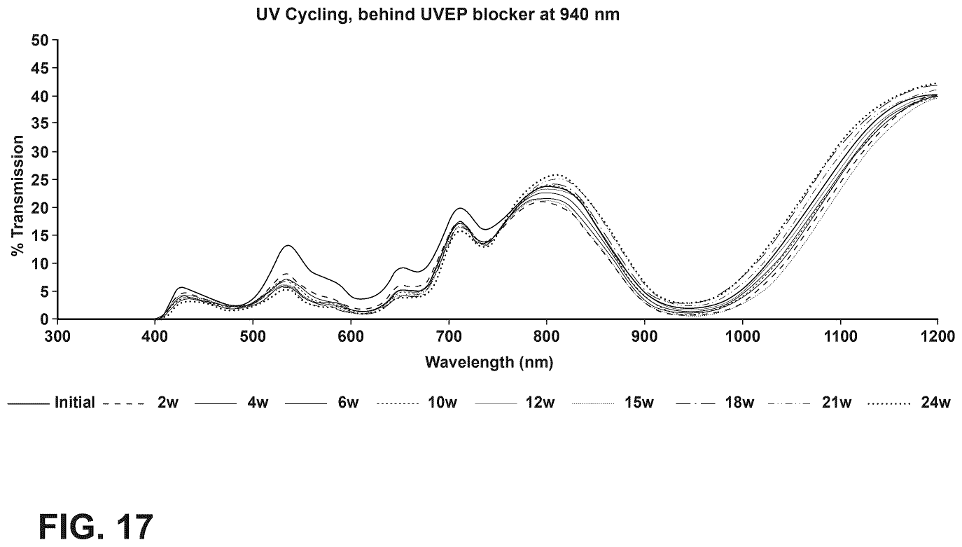

Referring to FIG. 17, the device was UV cycled alternating between 3 hours darkened state followed by 1 hour in the clear stated all under UV exposure. This tested the device after 21 weeks which resulted in a transmission change at 940 nm from 0.64 to 3.0%.

It will be understood by one having ordinary skill in the art that construction of the described disclosure and other components is not limited to any specific material. Other exemplary embodiments of the disclosure disclosed herein may be formed from a wide variety of materials, unless described otherwise herein.

According to one aspect of the present disclosure, an electro-optic assembly includes a front substrate defining a first surface and a second surface, the second surface includes a first electrically conductive layer, a back substrate defining a third surface and a fourth surface, the third surface includes a second electrically conductive layer, and an electro-optic medium disposed between the second surface and the third surface, the electro-optic medium has a decrease in transmission in near infrared light range with a first applied electrical potential to said electro-optic assembly, the electro-optic medium has a decrease in transmission in the visible light range with a second applied electrical potential applied to the electro-optic assembly.

According to another aspect of the present disclosure, the first applied electrical potential is smaller than the second applied electrical potential.

According to yet another aspect of the present disclosure, a reflective layer disposed on the third surface.

According to another aspect of the present disclosure, the decrease in transmission in the near infrared light range is greater than 50%.

According to yet another aspect of the present disclosure, the decrease in transmission in the near infrared light range is greater than 70%.

According to another aspect of the present disclosure, the decrease in transmission in the near infrared light range at the first applied electrical potential is at least two times greater than the decrease in transmission in the visible range at the first applied electrical potential.

According to yet another aspect of the present disclosure, the decrease in transmission in the near infrared light range at the first applied electrical potential is at least three times greater than the decrease in transmission in the visible range at the first applied electrical potential.

According to another aspect of the present disclosure, the electro-optic medium contains at least one of 1,1′-di(octyl) 4,4′-dipyridinium bis(tetrafluoroborate); 1,1′-bis(2-ethylhexyl)-4,4′-dipridinium-bis(tetrafluoroborate); 5,10-dihydro-5,10-dimethyl phenazine; 5,10-dihydro-5,10-dineopentyl phenazine; 5,10-dihydro-5,10-dineopentyl-2,7-bis(2-ethylhexyl) phenazine; and 5,10-dihydro-5,10-dineopentyl-2,7-di(isobutyl) phenazine.

According to yet another aspect of the present disclosure, the electro-optic medium is electrochromic.

According to another aspect of the present disclosure, a device for filtering near infrared and visible light, including a front substrate defining a first surface and a second surface, a back substrate defining a third surface and a fourth surface, a cavity is defined between the front substrate and the back substrate, an electro-optic medium disposed in the cavity, the electro-optic medium is operable between a clear state when no electrical potential is applied to said device, an intermediate state when a first electrical potential is applied to said device, and a darkened state when a second electrical potential is applied to said device.

According to yet another aspect of the present disclosure, the electro-optic medium absorbs near infrared light between 700 and 2,500 nm in the intermediate state and darkened state.

According to another aspect of the present disclosure, the electro-optic medium absorbs visible light between 380 and 780 nm in the darkened state.

According to yet another aspect of the present disclosure, the first electrical potential and the second electrical potential are between 0.4-1.0 V.

According to yet another aspect of the present disclosure, the electro-optic medium is electrochromic.

According to another aspect of the present disclosure, an electro-optic medium for absorbing near infrared and visible light includes a cathodic component, where the cathodic component is at least one of 1,1′-di(octyl) 4,4′-dipyridinium bis(tetrafluoroborate) or 1,1′-bis(ethylhexyl)-4,4′-dipridinium-bis(tetrafluoroborate), and an anodic component, where the anodic component includes, N-isobutyl-3,7-bis(dimethyl amino) phenothiazine, at least one of 5,10-dihydro-5,10-dimethyl phenazine or 5,10-dihydro-5,10-dineopentyl phenazine, and at least one of 5,10-dihydro-5,10-dineopentyl-2,7-bis(2-ethylhexyl) phenazine or 5,10-dihydro-5,10-dineopentyl-2,7-di(isobutyl) phenazine, and where the electro-optic medium has a first transmission of visible and near infrared light when no electrical potential is applied of greater than 55%, and has a second transmission of near infrared light when a first electrical potential is applied of less than 20%.

According to yet another aspect of the present disclosure, the electro-optic medium has a third transmission of visible light when a second electrical potential is applied of less than 10%, wherein the first electrical potential is less than the second electrical potential.

According to another aspect of the present disclosure, the decrease in the first transmission of near infrared light to the second transmission of near infrared light is greater than 70%.

According to yet another aspect of the present disclosure, the third transmission of near infrared light when the second electrical potential is applied of less than 1.0%.

According to another aspect of the present disclosure, the third transmission of visible light when the second electrical potential is applied of less than 8%.

According to yet another aspect of the present disclosure, electro-optic medium is used in an electrochromic device.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An electro-optic assembly, comprising:
a front substrate defining a first surface and a second surface, wherein the second surface comprises a first electrically conductive layer;
a back substrate defining a third surface and a fourth surface; wherein the third surface comprises a second electrically conductive layer; and
an electro-optic medium disposed between the second surface and the third surface, wherein the electro-optic medium has a decrease in transmission in near infrared light range with a first applied electrical potential to said electro-optic assembly, and wherein the electro-optic medium has a decrease in transmission in visible and near infrared light range with a second applied electrical potential applied to said electro-optic assembly.

2. The electro-optic assembly of claim 1 wherein the first applied electrical potential is smaller than the second applied electrical potential.

3. The electro-optic assembly of claim 1 wherein electro-optic assembly further comprises:
a reflective layer disposed on the third surface.

4. The electro-optic assembly of claim 1, wherein the decrease in transmission in the near infrared light range is greater than 50%.

5. The electro-optic assembly of claim 1, wherein the decrease in transmission in the near infrared light range is greater than 70%.

6. The electro-optic assembly of claim 1, wherein the decrease in transmission in the near infrared light range at the first applied electrical potential is at least two times greater than the decrease in transmission in the visible light range at the first applied electrical potential.

7. The electro-optic assembly of claim 1, wherein the decrease in transmission in the near infrared light range at the first applied electrical potential is at least three times greater than the decrease in transmission in the visible range at the first applied electrical potential.

8. The electro-optic assembly of claim 1, wherein the electro-optic medium contains at least one of 1,1′-di(octyl) 4,4′-dipyridinium bis(tetrafluoroborate); 1,1′-bis(2-ethylhexyl)-4,4′-dipridinium-bis(tetrafluoroborate); 5,10-dihydro-5,10-dimethyl phenazine; 5,10-dihydro-5,10-dineopentyl phenazine; 5,10-dihydro-5,10-dineopentyl-2,7-bis(2-ethylhexyl) phenazine; and 5,10-dihydro-5,10-dineopentyl-2,7-di(isobutyl) phenazine.

9. The electro-optic assembly of claim 1, wherein the electro-optic medium is electrochromic.

10. A device for filtering near infrared and visible light, comprising:
a front substrate defining a first surface and a second surface;
a back substrate defining a third surface and a fourth surface, wherein a cavity is defined between the front substrate and the back substrate; and
an electro-optic medium disposed in the cavity, wherein the electro-optic medium is operable between a clear state when no electrical potential is applied to said device, an intermediate state when a first electrical potential is applied to said device, and a darkened state when a second electrical potential is applied to said device.

11. The device for filtering near infrared and visible light of claim 10, wherein the electro-optic medium absorbs near infrared light between 700 and 2,500 nm in the intermediate state and the darkened state.

12. The device for filtering near infrared and visible light of claim 10, wherein the electro-optic medium absorbs visible light between 380 and 780 nm in the darkened state.

13. The device for filtering near infrared and visible light of claim 10, wherein the first electrical potential and the second electrical potential are between 0.4-1.0 V.

14. The device for filtering near infrared and visible light of claim 10, wherein the electro-optic medium is electrochromic.

15. An electro-optic medium for absorbing near infrared and visible light, comprising:
a cathodic component, wherein the cathodic component is at least one of 1,1′-di(octyl) 4,4′-dipyridinium bis(tetrafluoroborate) or 1,1′-bis(ethylhexyl)-4,4′-dipridinium-bis(tetrafluoroborate); and
an anodic component, wherein the anodic component comprises, N-isobutyl-3,7-bis(dimethyl amino) phenothiazine, at least one of 5,10-dihydro-5,10-dimethyl phenazine or 5,10-dihydro-5,10-dineopentyl phenazine, and at least one of 5,10-dihydro-5,10-dineopentyl-2,7-bis(2-ethylhexyl) phenazine or 5,10-dihydro-5,10-dineopentyl-2,7-di(isobutyl) phenazine, and wherein said electro-optic medium has a first transmission of visible and near infrared light when no electrical potential is applied of greater than 55%, and has a second transmission of near infrared light when a first electrical potential is applied of less than 20%.

16. The electro-optic medium for absorbing near infrared and visible light of claim 15, wherein said electro-optic medium has a third transmission of visible light when a second electrical potential is applied of less than 10%, wherein the first electrical potential is less than the second electrical potential.

17. The electro-optic medium for absorbing near infrared and visible light of claim 15, wherein the decrease in the first transmission of near infrared light to the second transmission of near infrared light is greater than 70%.

18. The electro-optic medium for absorbing near infrared and visible light of claim 16, wherein the third transmission of near infrared light when the second electrical potential is applied of less than 1.0%.

19. The electro-optic medium for absorbing near infrared and visible light of claim 16, wherein the third transmission of visible light when the second electrical potential is applied of less than 8%.

20. The electro-optic medium for absorbing near infrared and visible light of claim 15, wherein said electro-optic medium is used in an electrochromic device.
